(19) United States
(12) Patent Application Publication
(10) Pub. No.: US 2008/0289457 A1
(43) Pub. Date: Nov. 27, 2008

(54) Adjusting device for a hand-held tool

(76) Inventor: Dwain Anderson, Chevery (CA)

Correspondence Address: Franz BONSANG;c/o EQUINOX PROTECTION, 410-1500, Du College, St-Laurent, QC, H4L 5G6, CA

(21) Appl. No.: 11/802,600

(22) Filed: May 24, 2007

(51) Int. Cl. B25B 13/12

(52) U.S. Cl. 81/129; 60/592

(57) ABSTRACT

A hand tool device incorporates a fluid operated mechanism actuable by a plunger pressurizing a reservoir to force fluid past a valve to a fluid filled cylinder accommodating a piston carrying a contact member for clamping a work piece in the manner of a wrench. Continued operation of the plunger increases the pressure applied to the work piece.

### FIELD OF THE INVENTION

The present invention relates to hand tool devices, and is more particularly concerned with an adjusting device for hand-held tools, for example wrenches and the like, for applying torque to fixtures or work pieces, such as nuts and bolts.

### BACKGROUND OF THE INVENTION

In my U.S. Pat. No. 6,973,857 I describe such a hand tool device which incorporates fluid operable contact members which is moveable into alternate clamping positions in relation to a work piece by the actuation of a button. The contact members are carried by pistons sliding within opposed cylinders having at their full bore ends resiliently loaded ball valves. When it is desired to effect clamping action by one of the contact members in relation to a work piece, the button is depressed and in so doing the valves are unseated since being physically pushed by the stem of the button thus allowing fluid to eventually flow between the cylinders. By manually pushing the other contact member, fluid flow occurs such that the piston of the contact member associated with the work piece is forced along its cylinder to extend the contact member into the desired clamping position. Release of the button allows the valves to reseat and to lock the contact members in position.

Whilst the hand tool device of this prior art functions adequately well, it requires two-handed operation and manual effort in addition to the fluid, e.g. hydraulic, force applied to the contact member.

Accordingly, there is a need for an improved adjusting device for hand-held tools.

### SUMMARY OF THE INVENTION

It is therefore a general object of the present invention to provide an improved adjusting device for hand-held tools.

An advantage of the present invention is that the adjusting device obviates the need for dual-handed operation.

Another advantage of the present invention is that the adjusting device enables the user to apply added clamping pressure single-handedly to a contact member in contact with a work piece.

A further advantage of the present invention is that the adjusting device facilitates release of the clamping pressure when desired to disengage the contact member from the work piece.

Yet a further advantage of the present invention is that the adjusting device provides a simple and effective means of switching the clamping action from one end to another of a hand tool device with the use of one actuating member.

Still a further advantage of the present invention is that the piston of the adjusting device can be used to displace a pivotable and/or slidable contact member for clamping or holding a work piece therewith, such as in pliers and the like, or an open-face wrench or any other type of hand tools.

According to an aspect of the present invention, there is provided an adjusting device for a hand-held tool, comprising: a body defining at least one fluid-filled cylinder internally thereof; a piston movable within said cylinder and carrying a contact member extending exteriorly from the cylinder for contact in use with a work piece to be retained by the tool; a fluid reservoir in communication with said cylinder; a valve interposed between said reservoir and the cylinder for the control of fluid to and from the cylinder; and an actuating member associated with the fluid reservoir for initiating fluid flow across the valve, the actuating member being so adapted whereby upon continued actuation during extension of the contact member the force acting upon the work piece through the agency of the contact member increases.

The valve is preferably resiliently biased to a closed position on a seating provided for this within the cylinder.

The actuating member may be in the form of a plunger moveable within the reservoir with a button as simple pressure pad thereon.

The plunger may conveniently be resiliently biased fluidly away from the valve.

The valve is advantageously a ball valve normally biased into a closed position by an open-coiled compression spring.

In one embodiment of the present invention the body of the device defines a single cylinder with the valve being interposed between the reservoir and the cylinder. The actuating member comprises a resiliently-biased plunger operable within the reservoir and carrying a stem contactable with the valve to selectively actuate the valve.

In said one embodiment the stem of the plunger is grooved for registration with the valve and the plunger is rotatable within the reservoir, rotation of the stem in use causing the valve to open to release pressure fluid from the cylinder into the reservoir thereby withdrawing the contact member. The plunger conveniently includes an externally protruding grip for rotation thereof by a user. A lever may be pivoted to the body of the device and is operable upon the actuating member to operate the same.

In another embodiment of the present invention the body of the device is elongate and defines first and second fluid-filled cylinders internally thereof, the cylinders being in opposition between ends of the body. A piston is moveable within each cylinder and each carries a contact member extending exteriorly from the respective cylinder for contact in use with a work piece. A resiliently biased valve is interposed between said reservoir and a respective cylinder for the control of fluid to and from the respective cylinder. A switching element is coupled to the actuating member to direct in use fluid flow from the reservoir to a respective cylinder. The actuating member comprises a resiliently-biased plunger operable within the reservoir. Each valve is conveniently in the form of a ball valve and is provided with a main spring and a secondary spring, the main spring being disposed within a respective cylinder and the secondary spring being located in opposition thereto, each said secondary spring being stronger than the corresponding main spring.

The switching element may be in the form of an apertured disc mounted on the actuating member in such manner as to selectively register with the reservoir to permit or prevent fluid flow across the disc to a selected cylinder.

In yet another embodiment of the present invention the valve is resiliently biased into an opened position, and the actuating member comprises a resiliently biased plunger. The valve is conveniently a ball valve provided with a main spring and a secondary spring, the main spring being disposed within the cylinder, and the secondary spring being located in opposition thereto and being stronger than the main spring.

In a further embodiment of the present invention again the body is of elongate form defining first and second fluid-filled cylinders internally thereof, the cylinders being in opposition between ends of the body. A piston is moveable within each cylinder and each piston carries a contact member extending exteriorly from the respective cylinder for contact in use with a work piece to be retained by the tool. The device comprises two reservoirs in communication with the respective cylinders, a resiliently biased valve being interposed between a respective reservoir and the corresponding cylinder for the control of fluid therebetween,and an actuating member associated with each reservoir for initiating fluid flow across the corresponding valve. Each actuating member comprises a resiliently-biased plunger operable within the corresponding reservoir. The actuating members are so adapted that upon actuation of one of said actuating members to initiate fluid flow across a respective valve into one cylinder to pressurize the same, depressurization of the other cylinder occurs. Each actuating member is preferably in the form of a plunger moveable within the reservoir and carries a stem for initiating actuation of the valve associated with said other cylinder.

Conveniently, in use, the movement of the actuating member causes an increase in fluid pressure in its respective reservoir thereby to open said valve of the respective cylinder to extend the corresponding piston and its respective contact member and simultaneously to effect contact of the stem with the other said valve to release fluid from the other said cylinder thus retracting the other said piston and its contact member.

The fluid used in all the embodiments is conveniently hydraulic oil.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is an end view of an adjusting device for a hand-held tool in accordance with a first embodiment of the present invention;

FIG. 2 is a sectional view taken along line 2-2 of FIG. 1;

FIG. 3 is a plan view of a second embodiment;

FIG. 3a is an end view of the device of FIG. 3;

FIG. 4 is a sectional view taken along line 4-4 of FIG. 3a;

FIG. 5 is an end view of a third embodiment;

FIG. 6 is a sectional view taken along line 6-6 of FIG. 5;

FIG. 6a is a partially broken enlarged sectional view taken along line 6a-6a of FIG. 6;

FIG. 7 is an end view of a fourth embodiment;

FIG. 8 is a sectional view taken along line 8-8 of FIG. 7;

FIG. 8a is a sectional view taken along line 8a-8a of FIG. 8;

FIG. 9 is an end view of a modified fourth embodiment; and

FIG. 10 is a sectional view taken along line 10-10 of FIG. 9.

### DETAILED DESCRIPTION OF THE PREFERRED EMBODIMENTS

With reference to the annexed drawings the preferred embodiments of the present invention will be herein described for indicative purpose and by no means as of limitation.

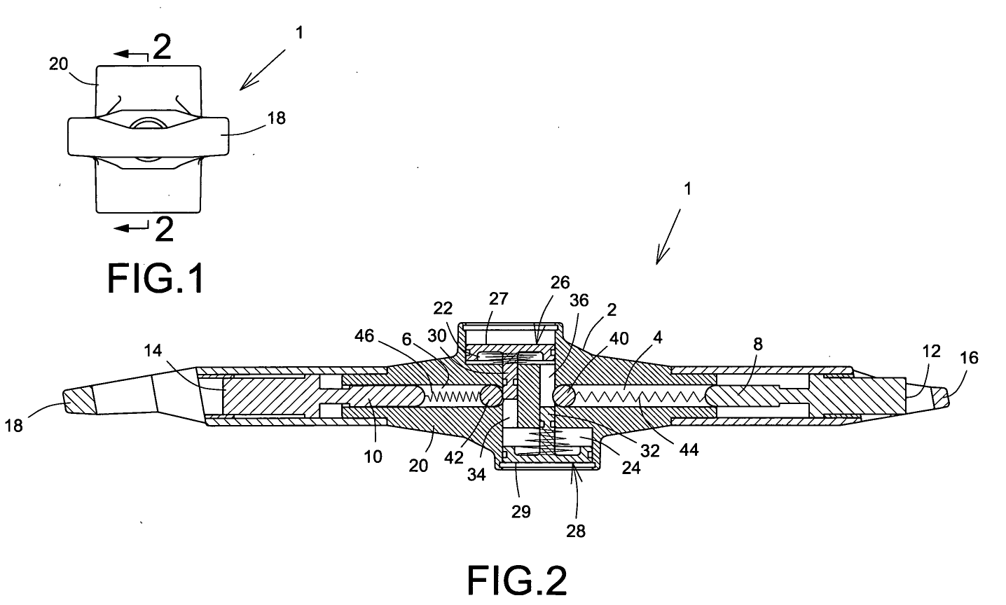

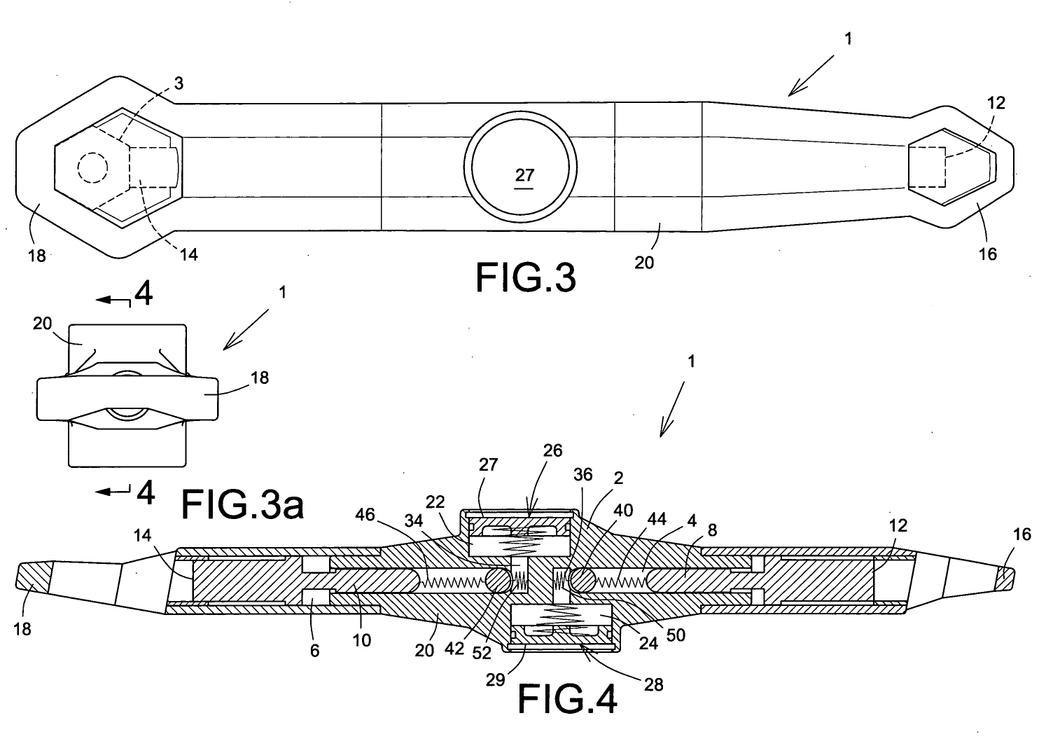

Reference is now made to FIGS. 1 and 2. The adjusting hand tool device is shown generally at 1 and comprises a double-ended elongate body 2 defining therewithin two typically axially aligned (they could be angled without departing from the scope of the present invention) opposed cylinders 4, 6 within each of which is accommodated a respective piston 8,10. The cylinders are typically filled with hydraulic oil. The piston 8,10 each carry a contact member 12, 14 for contact with a work piece 3 (shown in dotted lines in FIG. 3), the members 12, 14 extending exteriorly of the body 2 as shown which has at each end a typically fixed ring 16, 18 for locating the work piece 3 in use.

Intermediate the cylinders 4, 6 is a control block 20 in which are formed two reservoirs 22, 24 each having an actuating member such as a spring-loaded plunger 26, 28 (with conical coil springs being shown) or the like respectively slidable therewithin in close fitting manner (sealed). Each plunger 26, 28 has a button-like head 27, 29. The plungers 26, 28 respectively carry stems 30, 32 which sealably slide within guide channels 34, 36 formed in the block to prevent fluid communication between the two reservoirs 22, 24 (including the corresponding channels 34, 36).

A ball valve 40, 42 is seated within the end of a respective cylinder 4, 6 and is resiliently loaded as by a spring 44, 46 extending between the respective piston 8, 10 and the valve 40, 42.

In operation of the first embodiment, one end ring 16 is located over a work piece 3 by a user and the relatively lower plunger 28 (as shown in the drawing) is depressed by the user the oil from the reservoir 24 to become pressurized and in so doing the ball valve 42 is lifted off its seating against the action of the spring 46 thus allowing the oil to enter the cylinder 6 to extend the contact member 14 into the ring space. At the same time the stem 32 of the plunger 28 contacts the opposite ball valve 40 to lift it from its seating thus allowing egress of oil from the cylinder 4 and releasing the contact member 12. At the same time the oil escaping from the cylinder 4 pushes the plunger 26 to a starting position within the respective reservoir 22. Furthermore, release of manual pressure from the plunger 28 allows the valve 42 to become reseated under the action of the spring 46, thus locking the contact member 14 onto the work piece. When the tool is to be released from its clamping position, the plunger 26 is actuated whereby its stem 30 contacts the valve 42 to push it off its seating to allow oil flow from the cylinder 6. At the same time oil is forced from the reservoir 22 into the guide channel 36 to release the valve 40 to allow oil flow into the cylinder 4.

Operation of the contact member 12 is the same mutatis mutandis as for the contact member 14.

It will be well understood that whilst a user continues to apply pressure to a plunger, the corresponding contact member continues to be increasingly pressurized.

Referring now to FIGS. 3, 3a and 4, a second embodiment of adjusting hand tool device is shown and this embodiment differs from the first embodiment by providing a differently formed control block 20, which again defines separate reservoirs 22, 24 with respective plungers 26, 28 that are not provided with any stems. The reservoirs 22, 24 have channels 34, 36 each leading separately to the cylinders 4, 6 via the valves 40, 42. In this embodiment there is provided for each ball valve a secondary spring 50, 52 accommodated in respective channels 34, 36 opposed to the main springs 44, 46. All other features of this embodiment correspond to those of the first embodiment and are not described specifically again.

In this second embodiment, when it is desired to apply clamping pressure to a work piece 3 registering within one of the rings 16, 18 the appropriate plunger 26, 28 is operated to push oil from the reservoir 22, 24 into the fluid-filled cylinder 4, 6 and initiate displacement of the contact member 12, 14. Once the member 12, 14 contacts the work piece, the user stops depressing the plunger 26, 28 and starts rotating the tool around the work piece to pressurize the oil in the respective reservoir 22, 24. With the increasing pressure within the relevant cylinder, the ball valve reseats under the action of the oil pressure to lock the oil within the cylinder. However, once pressure on the work piece is removed the secondary spring 50, 52, which is of greater strength than the main spring 44, 46, overcomes the resistance of the main spring and lifts the valve 40, 42 off its seating to allow back flow of the oil into the reservoir 22, 24.

In this second embodiment, the contact members and their respective active components operate independently of each other.

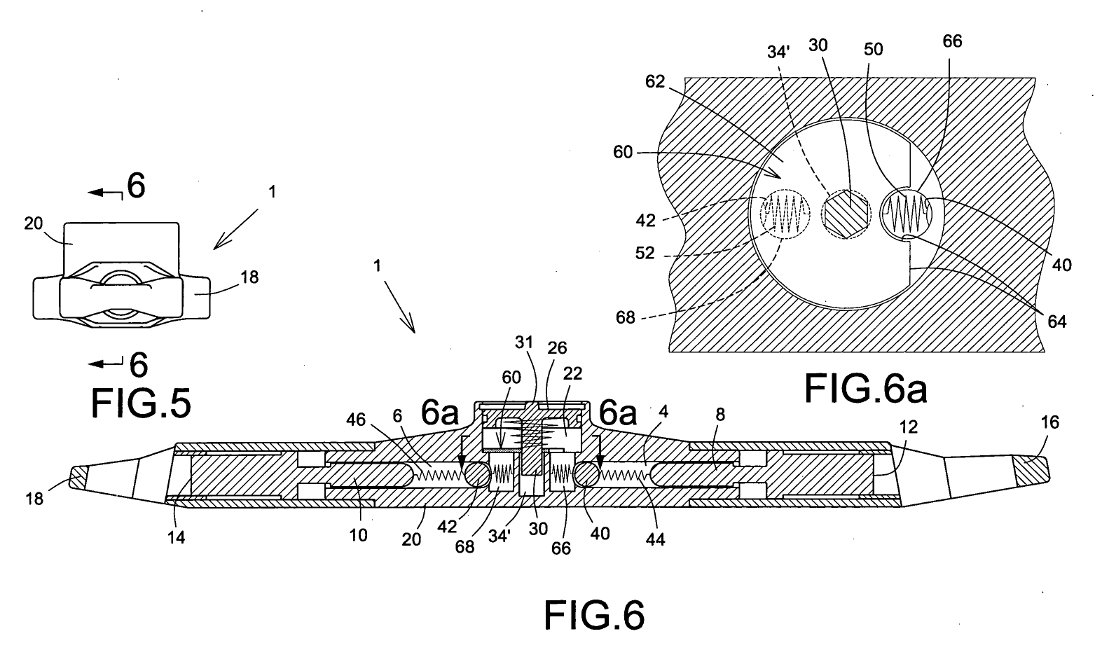

Referring now to FIGS. 5, 6 and 6a, a third embodiment of an adjusting hand tool device comprises similar features to those shown in FIGS. 3, 3a and 4 with the exception of the control block 20 which houses a single reservoir 20 with its associated spring-loaded plunger 26 which carries a stem 30 of hexagonal cross section (any other non-circular shape could obviously be considered without departing from the scope of the present invention) as can be seen more distinctly in FIG. 6a, and is rotatably moveable within the generally cylindrical guide bore 34′. A selector element in the form of a disc 60 sealably engages on the stem 30 and is provided with blanking zone 62 and a cut-out 64 which latter is shown in FIGS. 6 and 6a registering with a bore 66 extending from the reservoir 22 and opening into the end of the cylinder 4, a similar bore 68, shown as being blocked by the disc 60, also extends from the reservoir 22 to open into the end of the cylinder 6. The ball valves 40, 42 are spring-loaded on opposite sides as with the previous embodiment, with the secondary springs 50, 52 located within the respective bore 66, 68.

In operation of this embodiment with the orientation of the disc 60 as depicted, downward pressure of the plunger 26 causes oil to flow from the reservoir 20 into the bore 66 and thence past valve 40 into the cylinder 4 to extend the piston 8 and thus the contact member 12 into a clamping mode. As with the previous embodiment as the pressure on the contact member reduces upon rerleasing the work piece 3 so does the oil pressure inside the cylinder 4 and the secondary spring 50 causes the valve 40 to unseat and allow retraction of the piston 8 and the contact member 12. The backflow of oil resets the plunger 26. When it is desired to use the other contact member 14, the plunger 26 is rotated, using an externally protruding and generally diametrically extending grip 31, to bring the cut-out 64 into registration with bore 68 leading to the cylinder 6 while sealably blocking the bore 66. The actuation of the plunger 26 is now capable of pressurizing the cylinder 6 to operate the piston 10 and the contact member 14 carried thereby.

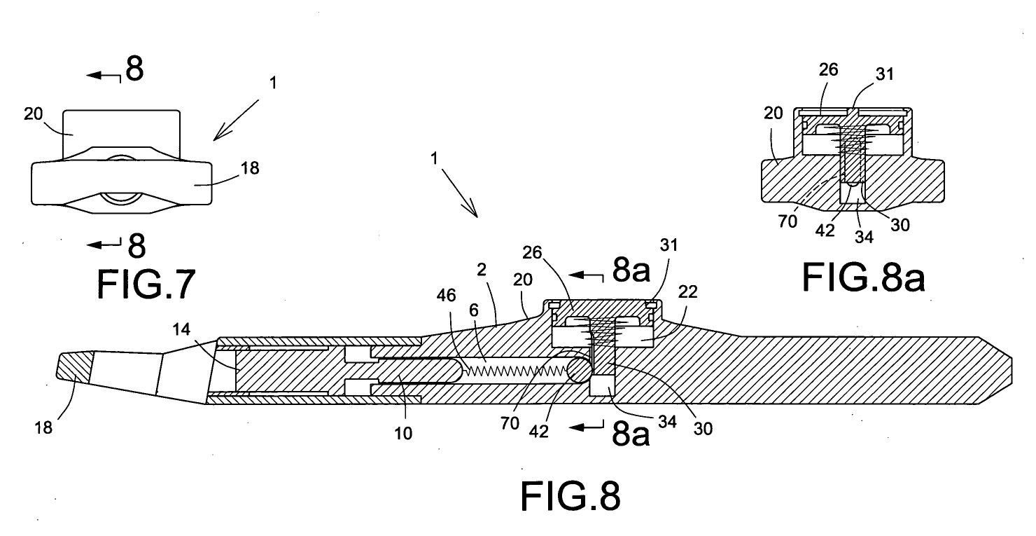

Referring now to FIGS. 7, 8, and 8a, the adjusting hand tool device of this fourth embodiment has but a single cylinder 6 formed within the body 2 and has a single reservoir 20 with the spring-loaded plunger 26 slidably operable therewithin. The plunger carries a stem 30 moveable within the associated guide channel 34, the stem 30 having a groove 70 formed therein for clearing the ball valve 42 which partly extends into the channel 34 as shown and to allow the oil to flow between the reservoir 22 and the cylinder 6 via the channel 34. When it is required to operate the hand tool device, the plunger 26, with the groove 70 in register with the valve 42, is depressed to expel oil from the reservoir 20 into the groove 70 and past the valve 42 into the cylinder 6 to extend the contact member 14 into the ring 18. Continuing pressure on the plunger 26 increases pressure on the piston. Release of the plunger allows the pressurized oil in the cylinder 6 and the spring 46 to reseat the valve 42 and lock the tool device in its clamping mode. When it is desired to release the device, the plunger is rotated using the grip 31 thus causing the stem 30, the walls of the groove 70, to move the ball valve 42 off its seat to allow backflow of oil into the reservoir 22.

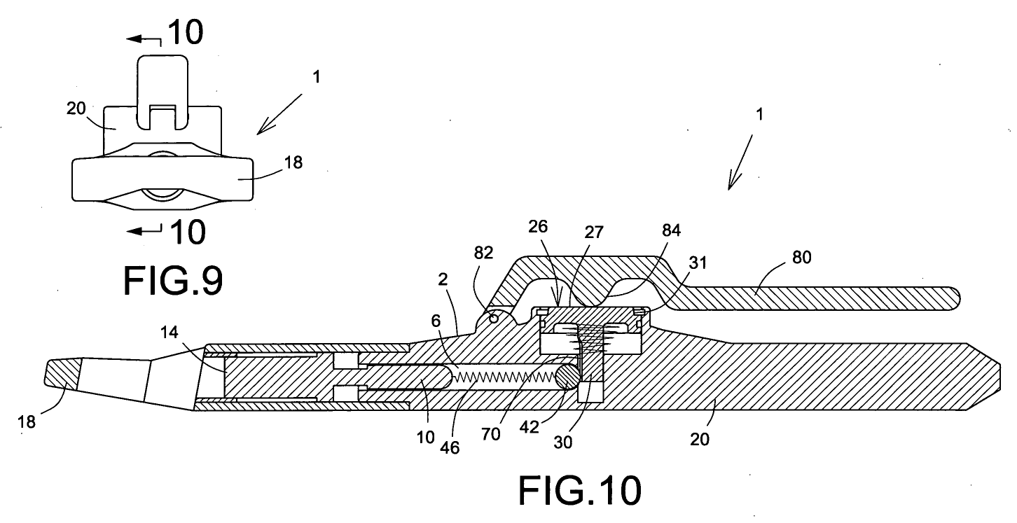

Turning now to FIGS. 9 and 10, there is shown a modified version of the fourth embodiment in which a lever 80 is hinged at 82 to the body 2 to provide a pivot, the lever having a protuberance 84 for contacting the grip 31 of the button-like head 27 of the plunger 26. The provision of the lever 80 affords greater pressure to be applied to the plunger 26. Release of the pressure in the cylinder is again effected by rotating the plunger to move the valve off its seating.

It is to be understood that with all embodiments of the present invention continued operation of the plunger(s) causes increased clamping pressure on the contact member.

While specific embodiments of the adjusting device for hand-held tools of the present invention has been described, those skilled in the art will recognize many alterations that could be made within the spirit of the invention. The description provided herein is provided only for purposes of illustration, and not for purposes of limitation.

I claim:

1. An adjusting device for a hand-held tool comprising:
a body defining at least one fluid-filled cylinder internally thereof;
a piston movable within said cylinder and carrying a contact member extending exteriorly from the cylinder for contact in use with a work piece to be retained by the tool;
a fluid reservoir in communication with said cylinder;
a valve interposed between said reservoir and the cylinder for the control of fluid to and from the cylinder; and
an actuating member associated with the fluid reservoir for initiating fluid flow across the valve, the actuating member being so adapted whereby upon continued actuation during extension of the contact member the force acting upon the work piece through the agency of the contact member increases.

2. An adjusting device for a hand-held tool as claimed in claim 1, wherein the valve is resiliently biased into a closed position on a seating provided for this purpose within the cylinder.

3. An adjusting device for a hand-held tool as claimed in claim 1, wherein the actuating member is in the form of a plunger moveable within the reservoir.

4. An adjusting device for a hand-held tool as claimed in claim 3, wherein the plunger is resiliently biased fluidly away from the valve.

5. An adjusting device for a hand-held tool as claimed in claim 1, wherein the valve is a ball valve.

6. An adjusting device for a hand-held tool as claimed in claim 1, wherein the body defines a single cylinder, the valve interposed between said reservoir and the cylinder being resiliently biased, and the actuating member comprising a resiliently-biased plunger operable within the reservoir and carrying a stem contactable with the valve to selectively actuate said valve.

7. An adjusting device for a hand-held tool as claimed in claim 6, wherein the stem of the plunger is grooved for registration with the valve and the plunger is rotatable within the reservoir, rotation of the stem in use causing the valve to open to release pressure fluid from the cylinder into the reservoir thereby withdrawing the contact member.

8. An adjusting device for a hand-held tool as claimed in claim 7, wherein the plunger includes an externally protruding grip for rotation thereof by a user.

9. An adjusting device for a hand-held tool as claimed in claim 7, wherein a lever is pivoted to the body and is operable upon the actuating member to operate the same.

10. An adjusting device for a hand-held tool as claimed in claim 1, wherein the body is elongate and defines first and second fluid-filled cylinders internally thereof, the cylinders being in opposition between ends of the body; a piston moveable within each cylinder and each carrying a contact member extending exteriorly from the respective cylinder for contact in use with a work piece; a resiliently biased valve interposed between said reservoir and a respective cylinder for the control of fluid to and from the respective cylinder; a switching element coupled to the actuating member to direct in use fluid flow from the reservoir to a respective cylinder; and the actuating member comprising a resiliently-biased plunger operable within the reservoir.

11. An adjusting device for a hand-held tool as claimed in claim 10, wherein each valve is a ball valve and is provided with a main and a secondary spring, the main spring being disposed within a respective cylinder and the secondary spring being located in opposition thereto, each said secondary spring being stronger than the corresponding main spring.

12. An adjusting device for a hand-held tool as claimed in claim 10, wherein the switching element is in the form of an apertured disc and is mounted on the actuating member in such manner as to selectively register with the reservoir to permit or prevent fluid flow across the disc to a selected cylinder.

13. An adjusting device for a hand-held tool as claimed in claim 10, wherein the plunger includes an externally protruding grip for rotation thereof by a user.

14. An adjusting device for a hand-held tool as claimed in claim 1, wherein the valve is resiliently biased into an opened position, and the actuating member comprises a resiliently-biased plunger operable within the reservoir.

15. An adjusting device for a hand-held tool as claimed in claim 14, wherein the valve is a ball valve and is provided with a main and a secondary spring, the main spring being disposed within the cylinder, and the secondary spring being located in opposition thereto and being stronger than the main spring.

16. An adjusting device for a hand-held tool as claimed in claim 1, wherein the body is elongate and defines first and second fluid-filled cylinders internally thereof, the cylinders being in opposition between ends of the body; a piston is movable within each cylinder and each piston carries a contact member extending exteriorly from the respective cylinder for contact in use with a work piece to be retained by the tool; the device further comprising fluid reservoirs in communication with respective said cylinders; a resiliently biased valve being interposed between a respective reservoir and the corresponding cylinder for the control of fluid therebetween; an actuating member associated with each reservoir for initiating fluid flow across the corresponding valve, each actuating member comprising a resiliently-biased plunger operable within the corresponding reservoir; the actuating members being further so adapted that upon actuation of one of said actuating members to initiate fluid flow across a respective valve into one cylinder to pressurize the same, depressurization of the other cylinder occurs.

17. An adjusting device for a hand-held tool as claimed in claim 16, wherein each actuating member is in the form of a plunger moveable within the reservoir and carries a stem for initiating actuation of the valve associated with said other cylinder.

18. An adjusting device for a hand-held tool as claimed in claim 17, wherein in use the movement of the actuating member causes an increase in fluid pressure in its respective reservoir thereby to open said valve of the respective cylinder to extend the corresponding piston and its respective contact member and simultaneously to effect contact of the stem with the other said valve to release fluid from the other said cylinder thus retracting the other said piston and its contact member.
